(19) United States
(12) Patent Application Publication
(10) Pub. No.: US 2023/0198052 A1
(43) Pub. Date: Jun. 22, 2023

(54) Metal Air Battery and Manufacturing Method of Air Electrode

(71) Applicant: Nippon Telegraph and Telephone Corporation, Tokyo (JP)

(72) Inventors: Mikayo Iwata, Musashino-shi, Tokyo (JP); Masaya Nohara, Musashino-shi, Tokyo (JP); Hiroaki Taguchi, Musashino-shi, Tokyo (JP); Yuzu Kobayashi, Musashino-shi, Tokyo (JP); Takeshi Komatsu, Musashino-shi, Tokyo (JP)

(21) Appl. No.: 17/925,802

(22) PCT Filed: May 25, 2020
(86) PCT No.: PCT/JP2020/020552

§ 371 Date: Nov. 16, 2022

(51) Int. Cl. H01M 12/06; H01M 4/42; H01M 4/46

(52) U.S. Cl. CPC H01M 12/06; H01M 4/42; H01M 4/463

(57) ABSTRACT

A metal air battery includes an air electrode containing a conductive material and a catalyst, a negative electrode containing a metal, and an electrolyte having ionic conductivity. The conductive material contains a co-continuous body of a three-dimensional network structure in which nanostructure bodies are branched, and the catalyst contains oxide having a cage-shaped crystal structure.

### TECHNICAL FIELD

The present disclosure relates to a metal air battery and a manufacturing method for an air electrode.

### BACKGROUND ART

In recent years, research and development on metal air batteries as candidates for a low environmental burden battery has been conducted. The metal air battery uses oxygen and water for a positive electrode active material, and metal such as magnesium, iron, aluminum, or zinc is used for a negative electrode, whereby the metal air battery is unlikely to cause soil contamination, unlikely to give damage to an ecosystem, and the like. These materials are materials of natural resources supplied in quantity and are inexpensive compared to rare metal.

In particular, a zinc air battery using zinc for a negative electrode is commercially available as a drive source of a hearing aid and the like. In addition, research and development on a magnesium air battery using magnesium for a negative electrode has been conducted as a low environmental burden battery (see Non Patent Literature (NPL) 1 and NPL 2).

### CITATION LIST

### Non Patent Literature

NPL 1: Y. Xue, 2 others, “Template-directed fabrication of porous gas diffusion layer for magnesium air batteries”, Journal of Power Sources, vol. 297, pp. 202-207, 2015.
NPL 2: N. Wang, 5 others, “Discharge behavior of Mg—Al—Pb and Mg—Al—Pb—In alloys as anodes for Mg-air battery”, Electrochimica Acta, vol. 149, pp. 193-205, 2014.

### SUMMARY OF THE INVENTION

### Technical Problem

However, in NPL 1, a fluorine resin is used as a binder for an air electrode, and in NPL 2, a metal containing lead, indium, or the like is used for a negative electrode; that is, those batteries are constituted of materials that may affect the natural environment such as soil contamination.

As a battery to resolve the above-described problems, a metal air battery in which magnesium, iron, aluminum, zinc, or the like is used for a negative electrode may be cited as an example. Although the above-cited metal air battery may eliminate environmental problems by not using environmental burden substances such as rare metal, there exists a problem of degradation in battery performance when the battery is constituted without using rare metal or the like.

The present disclosure has been contrived in view of the above problems, and an object thereof is to improve performance of a metal air battery.

### Means for Solving the Problem

An aspect of the present disclosure is a metal air battery that includes an air electrode containing a conductive material and a catalyst, a negative electrode containing a metal, and an electrolyte having ionic conductivity, in which the conductive material contains a co-continuous body of a three-dimensional network structure where nanostructure bodies are branched, and the catalyst contains oxide having a cage-shaped crystal structure.

An aspect of the present disclosure is a manufacturing method for an air electrode, the method including performing heat treatment on oxide having a cage-shaped crystal structure under an oxygen atmosphere to increase a concentration of oxygen ion radicals included in the oxide, performing heat treatment on the oxide with the increased concentration of the oxygen ion radicals under at least one type of atmosphere selected from the group consisting of atmospheres of an alkali metal, an alkaline earth metal, and titanium vapor to increase electrical conductivity of the oxide, and carrying the oxide with the increased electrical conductivity on a conductive material, in which the conductive material contains a co-continuous body of a three-dimensional network structure where nanostructure bodies are branched.

### Effects of the Invention

According to the present disclosure, the performance of a metal air battery with a low environmental burden may be enhanced.

### BRIEF DESCRIPTION OF DRAWINGS

FIG. 1 is a configuration diagram illustrating a configuration of a metal air battery according to an embodiment of the present disclosure.

FIG. 2 is a flowchart of a first manufacturing method.

FIG. 3 is a flowchart of a second manufacturing method.

FIG. 4 is a flowchart of a third manufacturing method.

FIG. 5 is a flowchart of a fourth manufacturing method.

FIG. 6A is an external view of a coin cell type zinc air battery of Example 1.

FIG. 6B is a bottom view of the coin cell type zinc air battery of Example 1.

FIG. 7 is a graph depicting a discharge curve of Example 1.

### DESCRIPTION OF EMBODIMENTS

Hereinafter, an embodiment of the present disclosure will be described with reference to the accompanying drawings.

### Configuration of Metal Air Battery

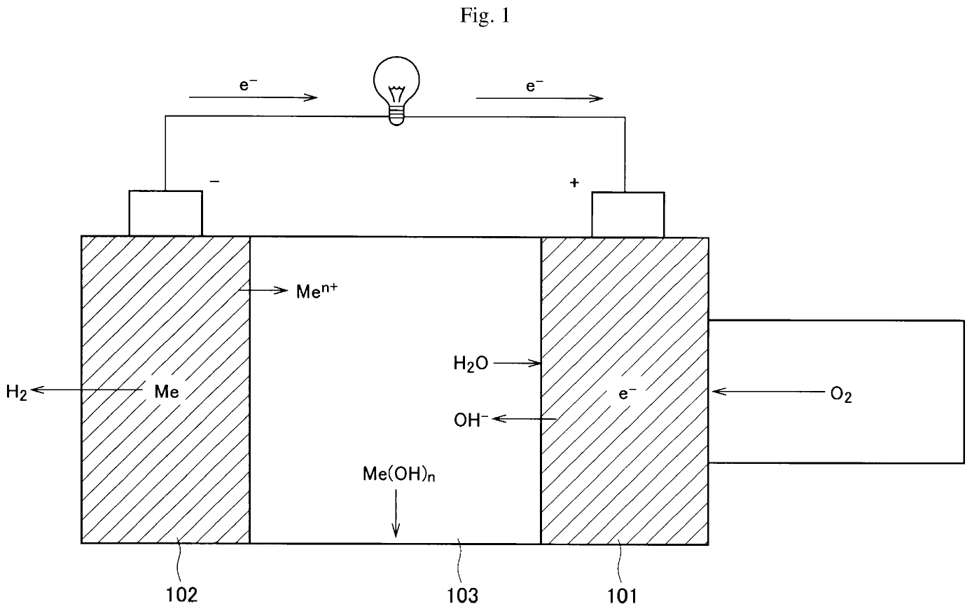

FIG. 1 is a configuration diagram illustrating a configuration of a metal air battery according to an embodiment of the present disclosure. The metal air battery uses air (oxygen) and water for a positive electrode active material, and a metal is used for a negative electrode active material. The metal air battery illustrated in the drawing includes an air electrode 101 of a gas diffusion type as a positive electrode, a negative electrode 102, and an electrolyte 103 disposed being interposed between the air electrode 101 and the negative electrode 102.

One surface of the air electrode 101 is exposed to the atmosphere and the other surface is in contact with the electrolyte 103. The air electrode 101 may contain a conductive material and a catalyst as constituent elements. A surface on the electrolyte 103 side of the negative electrode 102 is in contact with the electrolyte 103. The negative electrode 102 contains a metal. The electrolyte 103 has ionic conductivity and may be any of an electrolytic solution and a solid electrolyte. The electrolytic solution refers to an electrolyte in a liquid form. The solid electrolyte refers to an electrolyte in a gel form or in a solid form. Each of the above-mentioned constituent elements will be described below.

### (I) Air Electrode (Positive Electrode)

In the present embodiment, the air electrode 101 contains a conductive material and a catalyst.

### (I-1) Conductive Material

The conductive material of the air electrode 101 will be described. The conductive material contains a co-continuous body of a three-dimensional network structure in which nanostructure bodies are branched. Specifically, the conductive material contains a co-continuous body of a three-dimensional network structure in which a plurality of nanostructure bodies are integrated by non-covalent bonds. The co-continuous body is a porous body and has an integral structure. The nanostructure bodies are nanosheets, nanofibers, and the like. The co-continuous body of the three-dimensional network structure in which the plurality of nanostructure bodies are integrated by the non-covalent bonds has an elastic structure in which bonding portions between the nanostructure bodies are deformable.

It is only required that the nanosheet is constituted using at least one type of material selected from the group consisting of carbon, iron oxide, manganese oxide, magnesium oxide, molybdenum oxide, and a molybdenum sulfide compound, for example. The molybdenum sulfide compound is, for example, molybdenum disulfide, phosphorus doped molybdenum sulfide, or the like. It is only required that the elements of the above-mentioned materials are constituted of 16 types of essential elements indispensable for plant growth (C, O, H, N, P, K, S, Ca, Mg, Fe, Mn, B, Zn, Cu, Mo, Cl).

It is important for the nanosheet to have conductivity. The nanosheet is defined as a sheet-like substance having a thickness in a range from 1 nm to 1 μm, and planar longitudinal and lateral lengths of not less than 100 times the thickness. Graphene is an example of a nanosheet made of carbon. The nanosheet may be roll-shaped or wave-shaped, may be curved or bent, or may have any shape.

The nanofiber contains at least one type of material selected from the group consisting of carbon, iron oxide, manganese oxide, magnesium oxide, molybdenum oxide, molybdenum sulfide, and cellulose (carbonized cellulose). The nanofiber may be formed of at least one type of material selected from the above group. It is only required that the elements of the above-mentioned materials are constituted of 16 types of essential elements indispensable for plant growth (C, O, H, N, P, K, S, Ca, Mg, Fe, Mn, B, Zn, Cu, Mo, Cl).

It is also important for the nanofiber to have conductivity. The nanofiber is defined as a fiber-like substance having a diameter in a range from 1 nm to 1 μm, and a length of not less than 100 times the diameter. The nanofiber may be hollow or coiled, and may have any shape. The cellulose is made to have conductivity by carbonization and then used as discussed below.

For example, first, sol or gel in which nanostructure bodies are dispersed is frozen to be a frozen body (freezing step), and the frozen body is dried in vacuo (drying step), thereby making it possible to fabricate a co-continuous body to serve as the air electrode 101. It is possible to cause predetermined bacteria to produce gel as long as nanofibers formed by any of iron oxide, manganese oxide, silicon, and cellulose are dispersed in the gel (gel production step).

Alternatively, predetermined bacteria may be made to produce gel in which nanofibers formed by cellulose are dispersed (gel production step), and the gel may be heated and carbonized in an inert gas atmosphere to obtain a co-continuous body (carbonization step).

The average pore size of the co-continuous body constituting the air electrode 101 (conductive material) is preferably from 0.1 to 50 μm, and more preferably from 0.1 to 2 μm, for example. The average pore size is a value determined by a mercury penetration method.

The air electrode 101 does not have to use an additional material such as a binder, which is needed in the case of using carbon powder or the like, and therefore is advantageous from a cost standpoint and an environmental aspect as well.

Electrode reactions at the air electrode 101 and the negative electrode 102 will be described below. As for an air electrode reaction, a reaction represented by “1/2O₂+H₂O+2e⁻→>2OH⁻. . . (1)” proceeds due to oxygen in the air and the electrolyte making contact with each other on a surface of the conductive air electrode 101. On the other hand, as for a negative electrode reaction, a reaction represented by “Me→Meⁿ⁺+ne⁻. . . (2) (Me refers to the above-mentioned metal and n refers to the valence of the metal)” proceeds at the negative electrode 102 in contact with the electrolyte 103, so that the metal constituting the negative electrode 102 releases electrons and dissolves as metal ions having a valence of n in the electrolyte 103.

These reactions allow for discharge. The total reaction is represented by “Me+1/2O₂+H₂O→Me(OH)ₙ . . . (3)”, which is a reaction in which hydroxide is produced (precipitated). Compounds related to the above reactions are indicated along with the constituent elements in FIG. 1.

In this way, in the metal air battery, the reaction represented by Formula (1) proceeds on the surface of the air electrode 101, and thus it is considered to be preferable to generate a large number of reaction sites inside the air electrode 101.

The air electrode 101 as the positive electrode may be fabricated by a known process such as molding carbon powder with a binder; however, in the metal air battery, as described above, it is important to generate a large number of reaction sites inside the air electrode 101, and it is desirable for the air electrode 101 to have a large specific surface area. For example, in the present embodiment, it is preferable for the specific surface area of the co-continuous body constituting the air electrode 101 to be greater than or equal to 200 m²/g %, and more preferable to be greater than or equal to 300 m²/g.

In a case of a conventional air electrode that is fabricated by carbon powder being molded with a binder to form pellets, when the specific surface area is increased, the binding strength between pieces of the carbon powder decreases and the structure is deteriorated, which makes it difficult to discharge stably and lowers the voltage.

In contrast, because the air electrode 101 of the present embodiment contains the co-continuous body of the three-dimensional network structure in which the plurality of nanostructure bodies are integrated by the non-covalent bonds as described above, the above-described problems may be solved and the voltage may be raised.

### (I-2) Catalyst

The metal air battery of the present embodiment contains oxide having a cage-shaped crystal structure as a catalyst of the air electrode. As the catalyst (electrode catalyst) of the air electrode, it is preferable to use calcium dodeca-oxide aluminum hepta-oxide (12CaO·7Al₂O₃), which is highly active with respect to an oxygen reduction (discharge) reaction. By containing calcium dodeca-oxide aluminum hepta-oxide (12CaO·7Al₂O₃), the metal air battery of the present embodiment may enhance performance.

It is preferable for calcium dodeca-oxide aluminum hepta-oxide (12CaO·7Al₂O₃) to include oxygen ion radicals, which are active oxygen species, in an amount of not less than 10¹⁸ cm⁻³, more preferable to include the oxygen ion radicals in an amount of 5×10¹⁸ cm⁻³, and particularly preferable to include the oxygen ion radicals in an amount of 5×10¹⁸ to 1×10²² cm⁻³. In the present embodiment, the catalyst includes the above oxygen ion radicals, preferably has an electrical conductivity of not less than 3 S/cm, and more preferably has an electrical conductivity of 3 to 1000 S/cm.

In the air electrode of the metal air battery of the present embodiment, the electrode reaction proceeds at a three-phase interface site of the electrolyte/electrode catalyst/air (oxygen). That is, the electrolyte 103 permeates into the air electrode 101, the oxygen gas in the atmosphere is supplied at the same time, and then the three-phase interface site in which the electrolyte, electrode catalyst, and air (oxygen) coexist is formed. In the case where the electrode catalyst is highly active, oxygen reduction (discharge) proceeds smoothly and the battery performance is significantly enhanced.

An oxide having a cage-shaped crystal structure suitable for use as an electrode catalyst of an air electrode (positive electrode), such as calcium dodeca-oxide aluminum hepta-oxide (12CaO·7Al₂O₃), has a strong property of mutual interaction with oxygen, and can adsorb a large number of oxygen species on a surface of calcium dodeca-oxide aluminum hepta-oxide (12CaO·7Al₂O₃). In this way, the oxygen species adsorbed on the surface of calcium dodeca-oxide aluminum hepta-oxide (12CaO·7Al₂O₃) are used for oxygen reduction reactions as the oxygen source (active intermediate reactant) of Formula (1) discussed above, so that the above-mentioned reactions proceed with ease. As described above, calcium dodeca-oxide aluminum hepta-oxide (12CaO·7Al₂O₃) effectively functions as an electrode catalyst of the air electrode of the metal air battery.

In the metal air battery of the present embodiment, it is preferable that a larger number of reaction sites (three-phase portions of the electrolyte/electrode catalyst/air (oxygen)) for causing the electrode reactions be present in order to improve the reaction efficiency of the battery. From this perspective, in the present embodiment, it is important that the three-phase sites described above are present in large quantities on the electrode catalyst surface, and it is desirable that the catalyst in use have a large specific surface area. In the present embodiment, for example, the specific surface area of calcium dodeca-oxide aluminum hepta-oxide (12CaO·7Al₂O₃) is preferably not less than 5 m²/g, and more preferably not less than 10 m²/g.

alcium dodeca-oxide aluminum hepta-oxide (12CaO·7Al₂O₃) to be used in the present embodiment may be obtained by various methods. For example, it may be obtained by various synthetic techniques using known processes such as a solid phase method, liquid phase method, and gas phase method.

For example, as an embodiment of the synthetic technique, a solid phase is cited in which calcium carbonate (CaCo₃) and gamma aluminum oxide (γ-Al₂O₃) are mixed and fired at 500 to 1000° C., or preferably at 500 to 800° C. In the present embodiment, it is preferable to adjust calcium dodeca-oxide aluminum hepta-oxide (12CaO·7Al₂O₃) by a method including the solid phase method.

### (I-3) Adjustment of Air Electrode

The air electrode 101 may be adjusted as follows. The calcium dodeca-oxide aluminum hepta-oxide (12CaO·7Al₂O₃), which is a catalyst, is processed into a sputtering target or deposition material, and carried on a co-continuous body, which is a conductive material, by sputtering or deposition, thereby making it possible to adjust the air electrode. The sputtering target or deposition material may be fabricated by known methods.

### (II) Negative Electrode

Next, the negative electrode 102 will be described. The negative electrode 102 contains a negative electrode active material. The negative electrode active material is not limited as long as it is a material that can be used as a negative electrode material of the metal air battery, that is, one type of material selected from the group consisting of magnesium, aluminum, calcium, iron and zinc, or a material containing one type of material, as a main ingredient, selected from the above group. It is sufficient that the negative electrode 102 is configured using, for example, a member obtained by pressure-bonding a metal, a metal sheet, or powder to serve as a negative electrode onto metal foil of copper or the like.

The negative electrode 102 may be formed by known methods. For example, in a case where a magnesium metal is made to be the negative electrode 102, the negative electrode 102 may be fabricated by layering a plurality of metal magnesium foils to mold a predetermined shape.

### (III) Electrolyte

It is sufficient for the electrolyte 103 of the metal air battery to be a substance in which metal ions and hydroxide ions can move between the air electrode 101 (positive electrode) and the negative electrode 102. Examples of such substance may include metal salt containing potassium, sodium, or the like present abundantly on the Earth. It is sufficient for the metal salt to be composed of an element included in 16 types of essential elements indispensable for plant growth (C, O, H, N, P, K, S, Ca, Mg, Fe, Mn, B, Zn, Cu, Mo, Cl), seawater, or rain water.

For the electrolyte 103, at least one type of aqueous solution selected from the group consisting of acetic acid, sodium acetate, magnesium acetate, potassium acetate, calcium acetate, carbonic acid, sodium carbonate, magnesium carbonate, potassium carbonate, calcium carbonate, citric acid, sodium citrate, magnesium citrate, potassium citrate, calcium citrate, phosphoric acid, HEPES (4-(2-hydroxyethyl)-1-piperazineethanesulfonic acid), sodium pyrophosphate, and sodium metaphosphate may be used, for example. In a case where the electrolyte 103 has leaked to soil, magnesium does not give damage to the environment, but functions as fertilizer. Because of this, magnesium acetate, which is used as fertilizer as well, is preferable to be used as the electrolyte 103.

As another material constituting the electrolyte 103, for example, an oxide-based solid electrolyte or a sulfide-based solid electrolyte having ionic conductivity for transmitting metal ions and hydroxide ions may be used.

### (IV) Other Elements

The metal air battery of the present embodiment may include, in addition to the above-described constituent elements, a separator, a battery case, a structural member such as a metal mesh (for example, a titanium mesh), and other elements required for the metal air battery. For the above elements, known elements may be used. The separator is not limited as long as it is a fiber material, and a cellulose-based separator made from vegetable fiber or bacteria is preferable.

Next, a manufacturing method for a metal air battery will be described. The metal air battery of the present embodiment may be fabricated by appropriately disposing the air electrode 101 obtained through an air electrode manufacturing method to be described below, the negative electrode 102, and the electrolyte 103, along with other necessary elements based on the structure of the desired metal air battery, in an appropriate container such as a case. A conventionally known method may be applied to a manufacturing procedure of the above-discussed metal air battery.

Hereinafter, the fabrication of the air electrode 101 will be described.

### (V-1) Manufacturing Method of Conductive Material Used for Air Electrode

### First Manufacturing Method

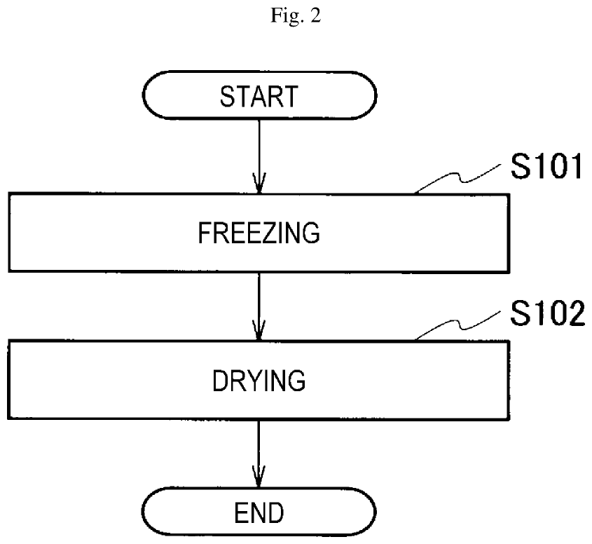

First, a first manufacturing method will be described with reference to FIG. 2. FIG. 2 is a flowchart for describing the first manufacturing method. First, in step S101, sol or gel in which nanostructure bodies such as nanosheets, nanofibers, or the like are dispersed is frozen to obtain a frozen body (freezing step). Next, in step S102, the obtained frozen body is dried in vacuo to obtain a co-continuous body (drying step).

Each of the steps will be described in detail below. The freezing step of step S101 is a step of maintaining or constructing a three-dimensional network structure of the co-continuous body using the nanostructure bodies to serve as a raw material of the co-continuous body. The co-continuous body has a three-dimensional network structure in which a plurality of nanostructure bodies are integrated by non-covalent bonds, and has stretchability.

Here, the gel means an object in which the dispersion medium loses its fluidity due to the three-dimensional network structure of the nanostructure body which is a dispersoid and becomes a solid state. Specifically, the gel means a dispersed system with a shear modulus of 10² to 10⁶ Pa. The dispersion medium of the gel contains at least one type of medium selected from the group consisting of aqueous media such as water (H₂O) and organic media such as carboxylic acid, methanol (CH₃OH), ethanol (C₂H₅OH), propanol (C₃H₇OH), n-butanol, isobutanol, n-butylamine, dodecane, unsaturated fatty acid, ethylene glycol, heptane, hexadecane, isoamyl alcohol, octanol, isopropanol, acetone, and glycerin. The dispersion medium may be composed of at least one type of medium selected from the above group.

Next, the sol means colloid containing a dispersion medium and a nanostructure body which is a dispersoid. Specifically, the sol means a dispersed system with a shear modulus of not greater than 1 Pa. The dispersion medium of the sol contains at least one type of medium selected from the group consisting of aqueous media such as water and organic media such as carboxylic acid, methanol, ethanol, propanol, n-butanol, isobutanol, n-butylamine, dodecane, unsaturated fatty acid, ethylene glycol, heptane, hexadecane, isoamyl alcohol, octanol, isopropanol, acetone, and glycerin. The dispersion medium may be composed of at least one type of medium selected from the above group.

In the freezing step, for example, the sol or gel in which nanostructure bodies are dispersed is stored in an appropriate container such as a test tube, and the sol or gel stored in the test tube is frozen by cooling the periphery of the test tube in a coolant such as liquid nitrogen. The freezing method is not limited as long as the dispersion medium of the gel or sol can be cooled to a temperature equal to or lower than the solidifying point, and the dispersion medium thereof may be cooled in a freezer or the like.

By freezing the gel or sol, the dispersion medium loses its fluidity and the dispersoids are fixed, whereby a three-dimensional network structure is constructed. Further, in the freezing step, the specific surface area may be freely adjusted by adjusting the concentration of the gel or sol, and the lower the concentration of the gel or sol, the larger the specific surface area of the obtained co-continuous body is. However, when the concentration is less than 0.01 wt. %, it is difficult for the dispersoids to construct a three-dimensional network structure, and thus the concentration of the dispersoids is preferably in a range from 0.01 to 10 wt. %.

By constructing a three-dimensional network structure with a large specific surface area by nanostructure bodies of nanofibers, nanosheets, or the like, the pores play a cushion role to exhibit excellent stretchability during compression or tension. Specifically, it is desirable for the strain of the co-continuous body at the elastic limit to be 5% or greater, and more desirable to be 10% or greater.

When the dispersoids are not fixed by freezing, a sufficiently large specific surface area cannot be obtained because the dispersoids cohere accompanying evaporation of the dispersion medium in a drying step subsequent to the freezing step, which makes it difficult to fabricate a co-continuous body having a three-dimensional network structure.

Details of the drying step of step S102 will be described below. The drying step is a step of extracting, from the dispersion medium, the dispersoids maintaining or constructing the three-dimensional network structure (the plurality of integrated nanostructure bodies) from the frozen body having been obtained in the freezing step.

In the drying step, the frozen body obtained in the freezing step is dried in a vacuum, and the frozen dispersion medium sublimates from its solid state. For example, the drying step is carried out by storing the obtained frozen body in an appropriate container such as a flask and evacuating the container. By placing the frozen body in a vacuum atmosphere, the sublimation point of the dispersion medium decreases, so that even a substance that does not sublimate under normal pressure can sublimate.

The degree of vacuum in the drying step is different depending on the dispersion medium to be used but is not limited as long as the dispersion medium sublimates at such a degree of vacuum. For example, when water is used as the dispersion medium, the degree of vacuum needs to be 0.06 MPa or less, but it takes time for the drying because heat is taken away as latent heat of sublimation. Therefore, the degree of vacuum is preferably in a range from 1.0×10⁻⁶ Pa to 1.0×10⁻² Pa. Further, heat may be applied by using a heater or the like at the time of drying.

The method of drying in the atmosphere causes the dispersion medium to change from the solid to a liquid, and then change from the liquid to a gas, whereby the frozen body comes to be in a liquid state and becomes fluid again in the dispersion medium and thus the three-dimensional network structure of the plurality of nanostructure bodies collapses. This makes it difficult to fabricate a co-continuous body having stretchability by the drying in an air pressure atmosphere.

### Second Manufacturing Method

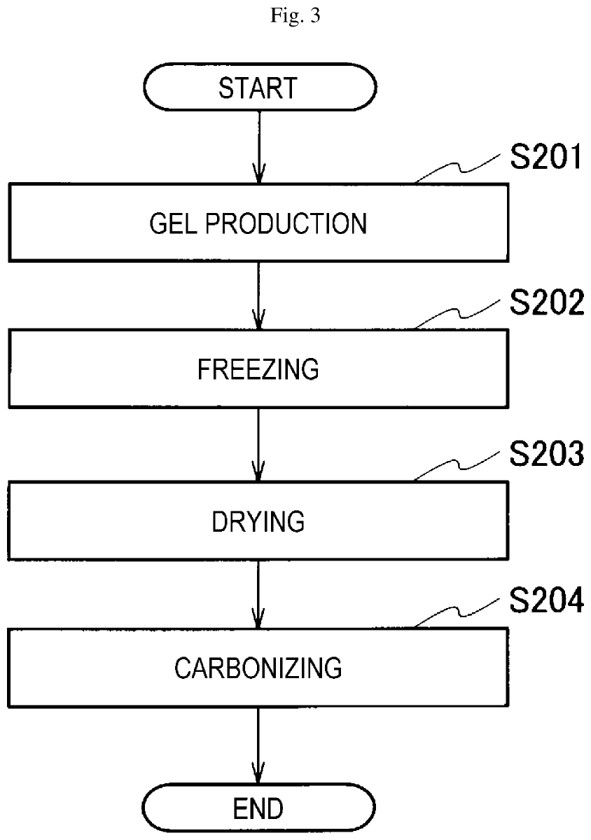

Next, a second manufacturing method will be described with reference to FIG. 3. FIG. 3 is a flowchart for describing the second manufacturing method. In the second manufacturing method, a co-continuous body is fabricated by a method different from that of the first manufacturing method.

First, in step S201, predetermined bacteria are caused to produce gel in which nanofibers of any of iron oxide, manganese oxide, or cellulose are dispersed (gel production step). A co-continuous body is fabricated using the gel obtained in this manner.

The gel produced by the bacteria takes fibers on the order of nm as a basic structure, and by fabricating a co-continuous body using this gel, the obtained co-continuous body has a large specific surface area. As described above, it is desirable for the air electrode of the metal air battery to have a large specific surface area, and therefore it is preferable to use the gel produced by the bacteria. Specifically, by using the gel produced by the bacteria, it is possible to synthesize an air electrode (co-continuous body) having a specific surface area of 300 m²/g or more.

The gel produced by the bacteria has a structure in which nanofibers are entwined in a coil or mesh shape, and further has a structure in which the nanofibers are branched based on a proliferation of the bacteria. Thus, the fabricated co-continuous body achieves excellent stretchability with which the strain at the elastic limit is 50% or greater. Therefore, the co-continuous body fabricated using the gel produced by the bacteria is suitable for the air electrode of the metal air battery.

Examples of bacteria may include known ones, for example, acetic acid bacteria such as Acetobacter xylinum subspecies sucrofermentans, Acetobacter xylinum ATCC23768, Acetobacter xylinum ATCC23769, Acetobacter pasturianus ATCC10245, Acetobacter xylinum ATCC14851, Acetobacter xylinum ATCC11142 and Acetobacter xylinum ATCC10821, Agrobackterium, Rhizobium, Sarcina, Pseudomonas, Achromobacter, Alcaligenes, Aerobacter, Azotobacter, Zoogloea, Enterobacter, Kluyvera, Leptothrix, Gallionella, Siderocapsa, Thiobacillus, and bacteria produced by culturing various types of variants created by performing variation processing on these bacteria with a known method using nitrosoguanidine (NTG) or the like.

As a method for obtaining a co-continuous body using the gel produced by the bacteria described above, as in the first manufacturing method, the gel is frozen to be a frozen body in step S202 (freezing step), and the frozen body is dried in vacuo to obtain the co-continuous body in step S203 (drying step). Note that, in a case of using gel produced by the bacteria in which nanofibers formed by cellulose are dispersed, the fabricated co-continuous body is heated and carbonized in a gas atmosphere in which the cellulose does not burn in step S204 (carbonization step).

Because bacteria cellulose, which is an ingredient contained in the gel produced by the bacteria, does not have conductivity, the carbonization step is necessary in which the co-continuous body is subjected to heat treatment and carbonization under an inert gas atmosphere so as to have conductivity when used as the air electrode. The co-continuous body carbonized in this manner has high conductivity, corrosion resistance, high stretchability, and a large specific surface area, and is suitable for use as the air electrode of the metal air battery.

After the co-continuous body having a three-dimensional network structure of bacteria cellulose has been synthesized by the aforementioned freezing step and drying step, it is sufficient that the bacteria cellulose is fired and carbonized at a temperature in a range from 500° C. to 2000° C., more preferably from 900° C. to 1800° C. in an inert gas atmosphere. The gas that does not burn cellulose is only required to be, for example, an inert gas such as a nitrogen gas or argon gas. The gas may be a reducing gas such as a hydrogen gas or carbon monoxide gas, or may be a carbon dioxide gas. In the present embodiment, a carbon dioxide gas or carbon monoxide gas is more preferred because it has an activating effect on a carbon material and thus the co-continuous body is expected to be highly activated.

(V-2) Manufacturing Method of Conductive Material Carrying Catalyst Used for Air Electrode

### Third Manufacturing Method

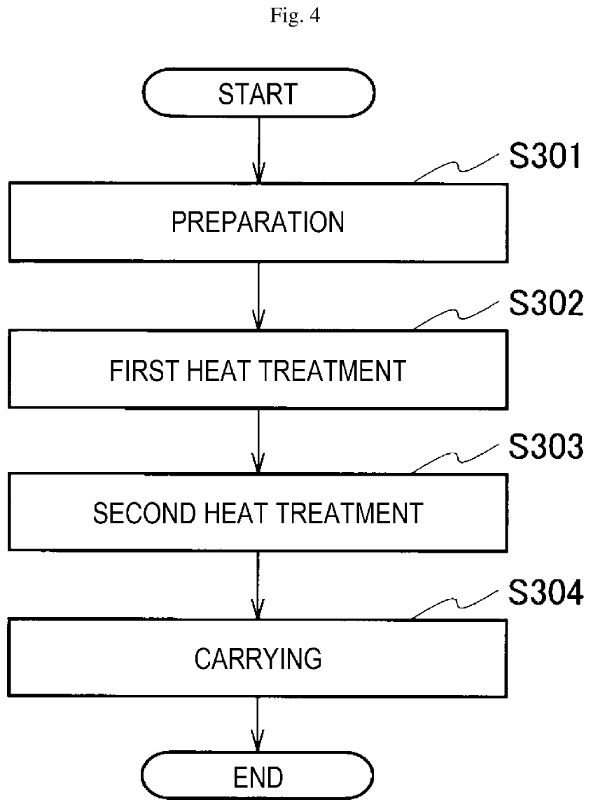

Next, a third manufacturing method will be described with reference to FIG. 4. FIG. 4 is a flowchart for describing the third manufacturing method.

The present manufacturing method is a method for manufacturing an air electrode of a conductive material carrying a catalyst. The present manufacturing method includes a preparation step (step S301), a first heat treatment step (step S302), a second heat treatment step (step S302), and a carrying step (step S304).

The preparation step is a step in which an oxide having a cage-shaped crystal structure (cage-shaped crystal structure oxide) is prepared as the catalyst (step S301). In the present manufacturing method, calcium dodeca-oxide aluminum hepta-oxide (12CaO·7Al₂O₃) is used as the cage-shaped crystal structure oxide. It is sufficient that the calcium dodeca-oxide aluminum hepta-oxide is adjusted in accordance with the synthetic techniques described in the column of (I-2) Catalyst.

The first heat treatment step is a step in which the cage-shaped crystal structure oxide is subjected to heat treatment under an oxygen atmosphere to increase the concentration of oxygen ion radicals included in the cage-shaped crystal oxide (step S302). Specifically, in the first heat treatment step, the concentration of oxygen ion radicals (active oxygen) included in the calcium dodeca-oxide aluminum hepta-oxide (12CaO·7Al₂O₃) having been adjusted in the preparation step is increased.

The second heat treatment step is a step in which the cage-shaped crystal structure oxide (in this case, 12CaO·7Al₂O₃) with the increased concentration of oxygen ion radicals is subjected to heat treatment under at least one type of atmosphere selected from the group consisting of alkali metal, alkaline earth metal, and titanium vapor, so as to increase electrical conductivity of the cage-shaped crystal structure oxide (step S303).

The carrying step is a step in which the cage-shaped crystal structure oxide (in this case, 12CaO·7Al₂O₃) is carried on the co-continuous body (conductive material) (step S304).

The specific procedure of the first heat treatment step includes performing heat treatment on the calcium dodeca-oxide aluminum hepta-oxide (12CaO·7Al₂O₃) obtained in the preparation step, under a dry air atmosphere, preferably an oxygen atmosphere at a temperature in a range from 200° C. to 800° C., preferably from 400° C. to 600° C. The oxygen ion (O²⁻) included in the calcium dodeca-oxide aluminum hepta-oxide (12CaO·7Al₂O₃) is free oxygen not bonded to a cation and is in a chemically highly active state.

The performing of the heat treatment causes thermal expansion and takes oxygen molecules present outside of the cage-shaped crystal structure oxide into the cage, whereby a reaction of “O²⁻+O²→O⁻+O₂⁻” occurs and the concentration of active oxygen increases. This makes it possible to increase the concentration of oxygen ion radicals (active oxygen) included in the calcium dodeca-oxide aluminum hepta-oxide (12CaO·7Al₂O₃). In the present embodiment, the concentration of the oxygen ion radicals is preferably not less than 10¹⁸ cm⁻³, more preferably not less than 5×10¹⁸ cm⁻³. When the oxygen ion radicals are contained in a high concentration, the number of electrons to be replaced in the second heat treatment step may be increased, and the conductivity of the cage-shaped crystal structure oxide may be improved by increasing the number of electrons.

The specific procedure of the second heat treatment step includes heating the cage-shaped crystal structure oxide (12CaO·7Al₂O₃) with the increased concentration of oxygen ion radicals (active oxygen) and an alkali metal, an alkaline earth metal, or titanium at a temperature of 500° C. to 800° C., preferably 600° C. to 700° C. under a sealed condition. Alkali metals, alkaline earth metals, and titanium are susceptible of providing electrons, and are stable themselves. The oxygen ions having been included in the cage-shaped crystal oxide by the first heat treatment step are taken out in the second heat treatment step, and the electron replacement may be achieved by providing the electrons of the alkali metal, alkaline earth metal, or titanium.

In the above-described procedure, the cage-shaped crystal oxide is subjected to heat treatment under at least one type of atmosphere selected from the group consisting of an alkali metal, an alkaline earth metal, and titanium vapor, so as to replace the oxygen ion radicals in the cage-shaped crystal structure oxide (12CaO·7Al₂O₃) with the electrons. This makes it possible to increase the electrical conductivity of the cage-shaped crystal structure oxide. With the present manufacturing method, the cage-shaped crystal structure oxide (12CaO·7Al₂O₃) used as the catalyst may be provided with an electrical conductivity of not less than 3 S/cm.

The alkali metal, alkaline earth metal, or titanium used in the second heat treatment step is not limited to any specific metal, but lithium and sodium are preferable, calcium is more preferable, and titanium is particularly preferable.

The ratio of the cage-shaped crystal structure oxide (12CaO·7Al₂O₃) of the second heat treatment step and the alkali metal, alkaline earth metal, or titanium is not limited as long as the electrical conductivity can be increased to be 3 S/cm or greater, but it is preferable for a ratio of (cage-shaped crystal structure oxide (12CaO·7Al₂O₃)):(alkali metal, alkaline earth metal, or titanium) to be 1:10 to 10:1.

The specific procedure of the carrying step is as follows: a sputtering target or deposition material is molded using the cage-shaped structure oxide (12CaO·7Al₂O₃) with the electrical conductivity having been increased in the second heat treatment step, and the catalyst is carried on the co-continuous body, which is a conductive material, using the sputtering target or deposition material. This step allows the co-continuous body to carry the catalyst in high dispersion without cohering the catalyst, so that a high catalytic activity may be expected. The molding method for the sputtering target or the deposition material is not limited to any specific one, and known techniques such as dissolution and sintering may be used.

In this way, the calcium dodeca-oxide aluminum hepta-oxide (12CaO·7Al₂O₃) with the increased electrical conductivity manufactured by the present manufacturing method may be more suitably used as an electrode catalyst of the air electrode.

### Fourth Manufacturing Method

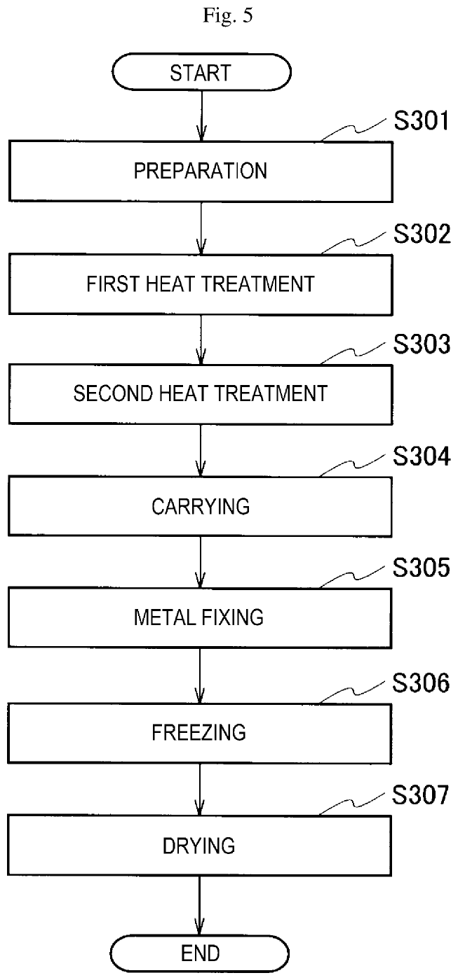

Next, a fourth manufacturing method will be described with reference to FIG. 5. FIG. 5 is a flowchart for describing the fourth manufacturing method. In the present manufacturing method, a metal fixing step (step S305), a freezing step (step S506), and a drying step (step S507) are added for the cage-shaped crystal structure oxide (12CaO·7Al₂O₃) with the increased electrical conductivity obtained by the third manufacturing method. As a result, in the present manufacturing method, metal nanoparticles are carried on the conductive material, a monoatomic metal is included at the same time in the cage-shaped crystal structure oxide (12CaO·7Al₂O₃), and the air electrode in which the cage-shaped crystal structure oxide is carried as the catalyst on the conductive material is manufactured.

The present manufacturing method is a manufacturing method for an air electrode of a conductive material carrying a catalyst thereon and includes the steps (steps S301 to S307) illustrated in FIG. 5. Steps S301 to S304 are the same as those of the third manufacturing method, where the cage-shaped crystal structure oxide (12CaO·7Al₂O₃) is carried on the co-continuous body.

The metal fixing step is a step of fixing the monoatomic metal to the cage-shaped crystal structure oxide (12CaO·7Al₂O₃) (step S305). Specifically, the metal fixing step causes the conductive material carrying the cage-shaped crystal structure oxide to be immersed in a solution containing a metal salt to heat the solution. The temperature is preferably from 20° C. to 100° C., and is more preferably from 40° C. to 80° C. The immersion time is preferably three days or more. The metal salt preferably uses at least one type of salt selected from the group consisting of iron, manganese, zinc, copper, and molybdenum. A solvent to dissolve the salt is only required to dissolve the salt to be used. The solvent contains, for example, at least one type of material selected from the group consisting of organic-base materials such as methanol and ethanol, and water-base materials such as water.

After the immersion, as in the first manufacturing method, it is sufficient that a frozen body is obtained by freezing in step S306 (freezing step), and the frozen body is dried in vacuo to obtain a catalyst carrying co-continuous body in step S307 (drying step). After the drying, it is preferable to perform firing in an inert gas atmosphere at 100° C. to 600° C., more preferably at 200° C. to 300° C. It is sufficient that the inert gas is an inert gas such as a nitrogen gas or an argon gas, and is also sufficient that the inert gas is a reducing gas such as a hydrogen gas or a carbon monoxide gas, a carbon dioxide gas, or the like. In the present manufacturing method, a hydrogen gas or a carbon monoxide gas is preferred because a metal salt carried on a conductive material is reduced and is expected to exhibit high catalyst activity by changing to metal nanoparticles. With the present manufacturing method, the cage-shaped crystal structure oxide includes a monoatomic metal. The monoatomic metal contains at least one type of element selected from the group consisting of iron, manganese, zinc, copper, and molybdenum.

When the air electrode synthesized by the above-described procedure of the present manufacturing method was observed by SEM, it was confirmed that particles having a size of several tens of nm were carried on the conductive material and particles having a size of several nm were carried on the surface of the cage-shaped crystal structure oxide. It was confirmed that, of these particles, the particles of the size of several nm did not have peaks derived from metal bonds and were included in monoatoms by the EXFAS spectrum.

Hereinafter, examples of the metal air batteries of the present embodiment will be described in detail. Note that the present embodiment is not limited to those illustrated in the following examples and may be appropriately changed within a range that does not change the gist thereof.

### Example 1

Example 1 is an example of using a co-continuous body of a three-dimensional network structure, as an air electrode, that is constituted using a plurality of nanosheets integrated by non-covalent bonds. In the following description, as an example, a manufacturing method in which graphene is used as a nanosheet is indicated, but the co-continuous body having a three-dimensional network structure may be adjusted by replacing graphene with a nanosheet of another material. The porosity indicated below was calculated by modeling a pore into a cylindrical shape, from a pore size distribution in the co-continuous body determined by a mercury penetration method.

First, a commercially available graphene sol [dispersion medium: water (H₂O), 0.4 wt. %, silicon “produced by Sigma-Aldrich] was set in a test tube and the test tube was immersed in liquid nitrogen for 30 minutes to completely freeze the graphene sol. After the graphene sol being completely frozen, the frozen graphene sol was taken out to be set in an eggplant flask and was dried in a vacuum of 10 Pa or less by a freeze dryer (manufactured by TOKYO RIKAKIKAI CO., LTD.), whereby a stretchable co-continuous body having a three-dimensional network structure containing graphene nanosheets was obtained.

The obtained co-continuous body was evaluated by being subjected to X-ray diffraction (XRD) measurement, scanning electron microscope (SEM) observation, porosity measurement, a tensile test, and BET specific surface area measurement. It was confirmed by the XRD measurement that the co-continuous body fabricated in the present example was single-phase carbon (C, PDF card No. 01-075-0444). The PDF card No. is a card number of Powder Diffraction File (PDF), which is a database collected by the International Centre for Diffraction Data (ICDD), and the same applies hereinafter.

By the SEM observation and mercury penetration method, the co-continuous body was confirmed to be a co-continuous body having an average pore size of 1 μm, where the nanosheets (graphene pieces) extended continuously. The BET specific surface area measurement of the co-continuous body was measured by the mercury penetration method, and it was found to be 510 m²/g. Further, the porosity of the co-continuous body was measured by the mercury penetration method, and it was found to be 90% or greater. From the tensile test result, it was confirmed that the co-continuous body did not exceed the elasticity region even when a strain of 20% was added by the tensile stress and was restored to the shape before the stress application.

The co-continuous body formed by the above-mentioned graphene was cut into a circular shape having a diameter of 14 mm with a punching blade, a laser cutter, or the like to obtain a gas diffusion type air electrode.

The negative electrode was adjusted by cutting a commercially available metal zinc plate (300-μm thickness, manufactured by The Nilaco Corporation) into a circular shape having a diameter of 14 mm with a punching blade, a laser cutter, or the like.

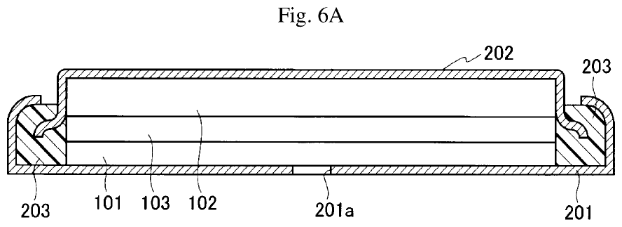

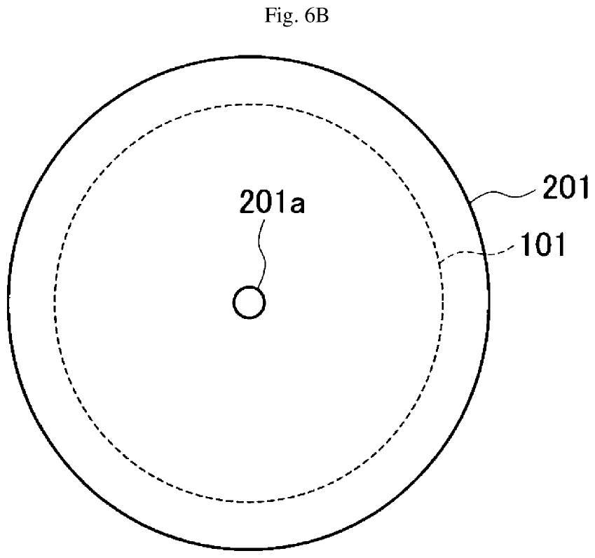

As an electrolytic solution, a solution in which potassium chloride (KCl, produced by KANTO CHEMICAL CO., INC.) was dissolved in pure water at a concentration of 1 mol/L was used. As a separator, a cellulose-based separator for a battery (manufactured by NIPPON KODOSHI CORPORATION) was used. The above-described air electrode, negative electrode, electrolytic solution to become the electrolyte, and separator were used to fabricate a coin cell type zinc air battery illustrated in FIGS. 6A and 6B.

FIG. 6A is a cross-sectional view of the coin cell type zinc air battery of the present example. FIG. 6B is a bottom view of the coin cell type zinc air battery of the present example when seen from the positive electrode side. First, the air electrode 101 described above was disposed in an air electrode case 201, on the inner side of which the peripheral edge portion of copper mesh foil (manufactured by MIT Japan) was fixed by spot welding. The air electrode case 201 has an air hole 201a therein. The peripheral edge portion of the negative electrode 102 using the metal zinc plate was fixed to the copper mesh foil (manufactured by MIT Japan) by spot welding, and the copper mesh foil was fixed to a negative electrode case 202 by spot welding. Next, the separator was set on the air electrode 101 disposed in the air electrode case 201, and then the electrolyte solution was injected into the set separator to obtain the electrolyte 103. Subsequently, the negative electrode case 202, to which the negative electrode 102 was fixed, was put on the air electrode case 201, and the peripheral edge portions of the air electrode case 201 and the negative electrode case 202 were caulked by a coin cell caulking machine, whereby the coin cell type zinc air battery including a gasket 203 formed of polypropylene was fabricated.

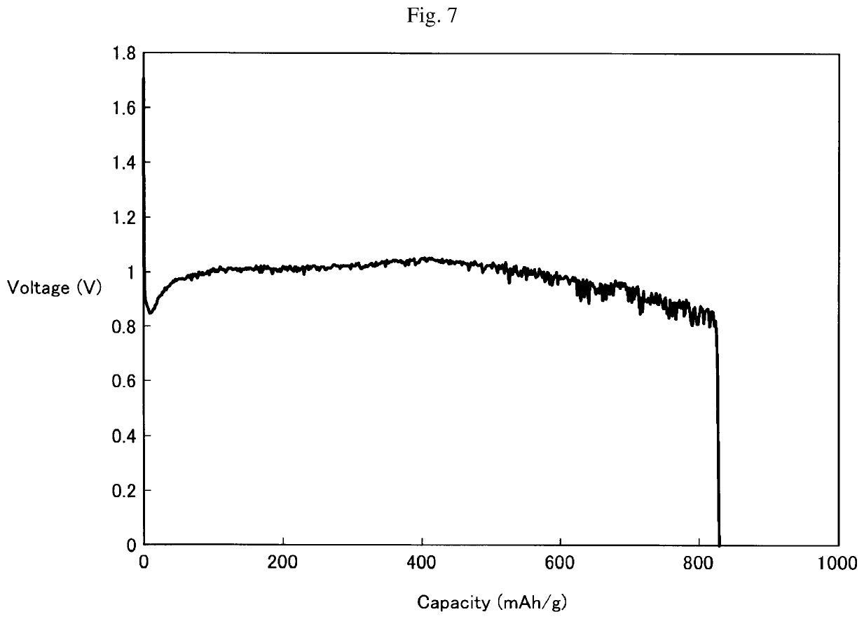

The battery performance of the fabricated coin cell type zinc air battery was measured. A discharge test was conducted first. In the discharge test of the zinc air battery, a commercially available charge/discharge measurement system (SD8 Battery Charge/Discharge System, manufactured by HOKUTO DENKO CORPORATION) was used, where energization was conducted at a current density per effective area of the air electrode of 0.1 mA/cm², and the measurement was performed until the discharge voltage dropped from the open circuit voltage to 0 V. In the discharge test of the zinc air battery, the measurement was performed in a thermostatic chamber at 25° C. (the atmosphere was normal living environment). The discharge capacity was expressed as a value per weight (mAh/g) of the air electrode including the co-continuous body. A discharge curve in the zinc air battery of the present example is depicted in FIG. 7.

As depicted in FIG. 7, it is understood that, when the co-continuous body is used for the air electrode, the average discharge voltage is 1.0 V and the discharge capacity is 810 mAh/g. The average discharge voltage is a battery voltage when the discharge capacity (405 mA/g in Example 1) is half the battery discharge capacity (810 mAh/g in the present example).

Table 1 indicates the discharge capacity of a zinc air battery when a co-continuous body was fabricated from each of the nanosheets of carbon (C), iron oxide (Fe₂O₃), manganese oxide (MnO₂), zinc oxide (ZnO), molybdenum oxide (MoO₃), and molybdenum sulfide (MoS₂) and was used as the air electrode.

TABLE 1

| Nanosheet Material | Discharge Capacity (mAh/g) |
|---|---|
| Graphene (C) | 810 |
| Iron oxide (Fe₂O₃) | 800 |
| Manganese oxide (MnO₂) | 800 |
| Zinc oxide (ZnO) | 790 |
| Molybdenum oxide (MoO₃) | 770 |
| Molybdenum sulfide (MoS₂) | 770 |

The discharge capacity of any of the zinc air batteries was 770 mAh/g or larger, which was a value larger than that of a first comparative example in which an air electrode using carbon powder described below was evaluated. It is conceivable that, also in each of the examples of the nanosheets formed of materials other than carbon, the specific surface area was large as in the case of graphene, and thus a discharge product [Zn(OH)₂] was efficiently precipitated, whereby the discharge capacity was improved.

### Example 2

Example 2 is an example of using a co-continuous body of a three-dimensional network structure, as an air electrode, that is constituted using a plurality of nanofibers integrated by non-covalent bonds. The air electrode was synthesized as follows. In the following description, as an example, a manufacturing method using carbon nanofibers is indicated, but the co-continuous body having a three-dimensional network structure may be adjusted by replacing carbon nanofibers with nanofibers of another material.

A co-continuous body evaluation method, a zinc air battery fabrication, and a discharge test method are similar to those in Example 1.

The co-continuous body was fabricated in a similar manner to that of the process described in Example 1, and carbon nanofiber sol [dispersion medium: Water (H₂O), 0.4 wt. %, produced by Sigma-Aldrich] was used as a raw material.

The obtained co-continuous body was evaluated by being subjected to XRD measurement, SEM observation, porosity measurement, a tensile test, and BET specific surface area measurement. It was confirmed by the XRD measurement that the co-continuous body fabricated in the present example was single-phase carbon (C, PDF card No. 00-058-1638). By the SEM observation and mercury penetration method, it was confirmed that the above-mentioned co-continuous body was a continuous body having an average pore size of 1 μm, where the nanofibers extended continuously. The BET specific surface area measurement of the co-continuous body was measured by the mercury penetration method, and it was found to be 620 m²/g. Further, the porosity of the co-continuous body was measured by the mercury penetration method, and it was found to be 93% or greater. From the tensile test result, it was confirmed that the co-continuous body of the present example did not exceed the elasticity region even when a strain of 40% was added by the tensile stress and was restored to the shape before the stress application.

A coin cell type zinc air battery similar to that of Example 1 was fabricated using the above-described co-continuous body formed with the carbon nanofibers for the air electrode. The discharge capacity of the fabricated zinc air battery in the present example is indicated in Table 2. In the present example, the discharge capacity was 850 mAh/g, which was a larger value than that in the case of using the co-continuous body formed with graphene of Example 1. It may be considered to be the above improvement in characteristics is brought by a smooth reaction at the discharge time because of using the co-continuous body having a higher level of stretchability.

Table 2 indicates the discharge capacity of a zinc air battery when a co-continuous body was fabricated from each of the nanofibers of carbon nanofiber (C), iron oxide (Fe₂O₃), manganese oxide (MnO₂), zinc oxide (ZnO), molybdenum oxide (MoO₃), and molybdenum sulfide (MoS₂) and was used as the air electrode.

TABLE 2

| Nanofiber Material | Discharge Capacity (mAh/g) |
|---|---|
| Carbon nanofiber (C) | 850 |
| Iron oxide (Fe₂O₃) | 830 |
| Manganese oxide (MnO₂) | 840 |
| Zinc oxide (ZnO) | 830 |
| Molybdenum oxide (MoO₃) | 820 |
| Molybdenum sulfide (MoS₂) | 820 |

The discharge capacity of any of the zinc air batteries was 800 mAh/g or larger, which was a generally larger value than that of the co-continuous body including nanosheets as in Example 1. It is conceivable that, also in each of the examples of these nanofibers, the stretchable air electrode precipitated a discharge product [Zn(OH)₂] efficiently as in the case of carbon nanofibers, whereby the discharge capacity was improved.

### Example 3

Next, Example 3 is described. Example 3 is an example in which a co-continuous body formed with a gel where cellulose produced by bacteria is dispersed is used as an air electrode. A co-continuous body evaluation method, a zinc air battery fabrication method, and a discharge test method are similar to those in Example 1 and Example 2.

### Adjustment of Bacteria-Produced Carbon

Using nata de coco (produced by FUJICCO Co., Ltd.) as a bacterial cellulose gel produced by Acetobacter xylinum, which is an acetic acid bacterium, a zinc air battery was fabricated in a similar manner to the process described in Example 1. After having dried the nata de coco in vacuo, a co-continuous body was carbonized by firing for two hours at 1200° C. in a nitrogen atmosphere, whereby an air electrode was fabricated.

The obtained co-continuous body (carbonized co-continuous body) was evaluated by being subjected to XRD measurement, SEM observation, porosity measurement, a tensile test, and BET specific surface area measurement. It was confirmed by the XRD measurement that the co-continuous body was single phase carbon (C, PDF card No. 01-071-4630). By the SEM observation, it was confirmed that the above-mentioned co-continuous body was a co-continuous body where the nanofibers with a diameter of 20 nm extended continuously. The BET specific surface area measurement of the co-continuous body was measured by the mercury penetration method, and it was found to be 830 m²/g. Further, the porosity of the co-continuous body was measured by the mercury penetration method, and it was found to be 99% or greater. Furthermore, from the tensile test result, it was confirmed that the co-continuous body did not exceed the elasticity region even when a strain of 80% was added by the tensile stress and was restored to the shape before the stress application, thereby exhibiting excellent stretchability even after the carbonization.

The discharge capacity of the zinc air battery in Example 3 is indicated in Table 3 given below. In Example 3, the discharge capacity was 1280 mAh/g. In Table 3 given below, the results of using co-continuous bodies formed with other bacteria-produced nanofibers are additionally indicated.

TABLE 3

| Catalyst/Co-continuous Body Material | Discharge Capacity (mAh/g) |
|---|---|
| Carbonized bacterial cellulose | 1280 |
| Bacteria-produced iron oxide | 1160 |
| Bacteria-produced MnO₂ | 1170 |

According to the present example, the following are conceivable: a co-continuous body having a high porosity and stretchability by BET specific surface area measurement was obtained; according to the zinc air battery using the above co-continuous body as the air electrode, a discharge product [Zn(OH)₂] was precipitated efficiently at the discharge time; and the reaction occurred smoothly because of excellent conductivity of carbon (C).

As indicated in Table 3, the discharge capacity of the zinc air battery by the air electrode using the co-continuous body formed with the bacteria-produced iron oxide was 1160 mAh/g, and the discharge capacity of the zinc air battery by the air electrode using the co-continuous body formed with the bacteria-produced manganese oxide was 1170 mAh/g; these values were larger that the values in Example 2. The co-continuous formed with bacteria-produced iron oxide and the co-continuous body formed with bacteria-produced manganese oxide were adjusted by the following procedure.

### Adjustment of Bacteria-produced Iron Oxide

As for the bacteria-produced iron oxide, Leptothrix ochracea, which is an iron bacterium, was put into a JOP liquid culture medium inside a test tube along with iron pieces (purity was 99.9% or more, manufactured by Kojundo Chemical Laboratory Co., Ltd.), and cultured at 20° C. for 14 days in a shaker. The JOP liquid culture medium is a culture medium where pH of 0.076 g of disodium hydrogen phosphate 12-hydrate, 0.02 g of potassium dihydrogen phosphate 2-hydrate, 2.383 g of HEPES [4-(2-hydroxyethyl)-1-piperazineethanesulfonic acid: buffer solution substance], and 0.01 mmol/L of iron sulfate in one liter of sterile groundwater was adjusted to be 7.0 with aqueous sodium hydroxide. The Leptothrix ochracea was purchased from American Type Culture Collection (ATCC).

After the culture, the iron pieces were removed, and the obtained gel was washed in pure water using a shaker for 24 hours. During the washing, the pure water was replaced three times. By using the washed gel as a raw material, a zinc air battery was fabricated in a similar manner to the process described in Example 1.

It is conceivable that, also in the case of the bacteria-produced nanofibers, the excellently stretchable air electrode having been produced by bacteria precipitated a discharge product [Zn(OH)₂] efficiently as in the case of the bacteria-produced carbon, whereby the discharge capacity was improved.

### Adjustment of Bacteria-Produced Manganese Oxide

Bacteria-produced manganese oxide was cultured and produced in the same manner as described above by using manganese pieces (purity was 99.9% or more, manufactured by Kojundo Chemical Lab. Co., Ltd.) with Leptothrix discophora, which is a manganese bacterium. The Leptothrix discophora was purchased from ATCC.

It is conceivable that, also in the case of the bacteria-produced nanofibers, the excellently stretchable air electrode having been produced by bacteria precipitated a discharge product [Zn(OH)₂] efficiently as in the case of the iron bacteria-produced iron oxide, whereby the discharge capacity was improved.

### Example 4

Example 4 describes a case in which calcium dodeca-oxide aluminum hepta-oxide (12CaO·7Al₂O₃) with increased electrical conductivity is further carried as a catalyst on a co-continuous body formed with nanofibers produced by bacteria. Powder of calcium dodeca-oxide aluminum hepta-oxide (12CaO·7Al₂O₃) was synthesized in the following procedure.

Synthesis of Calcium Dodeca-Oxide Aluminum Hepta-Oxide (12CaO·7Al₂O₃)

As the preparation step (FIG. 4: S301), commercially available calcium carbonate (CaCO₃) (produced by KANTO CHEMICAL CO., INC.) and commercially available gamma aluminum oxide (γ-Al₂O₃) (produced by KANTO CHEMICAL CO., INC.) were subjected to wet blending in alcohol, so as to adjust calcium (Ca) and aluminum (Al) to be at an atomic equivalent ratio of 12:14. The obtained raw material was subjected to firing at 800° C. for two hours in the air, thereby causing a solid phase reaction to occur. Thereafter, the raw material was coarsely ground using a mortar and a pestle, and then was finely ground using a ball mill.

The obtained powder was confirmed such that impurities were not contained in the calcium dodeca-oxide aluminum hepta-oxide (12CaO·7Al₂O₃) by the XRD measurement. The ESR measurement made it possible to determine the concentration of oxygen ion radicals included in the calcium dodeca-oxide aluminum hepta-oxide (12CaO·7Al₂O₃), and an absorption spectrum of active oxygen O₂⁻ (gₓ=2.00, g_{y}=2.01, g_{z}=2.07) and an absorption spectrum of active oxygen O⁻(gₓ=g_{y}=2.04, g_{z}=2.00) were integrated twice to find that the oxygen ion radicals in the amount of 1×10¹⁷/cm³ were contained. The specific surface area of the powder was found to be 10 m²/g when measured by the BET method. The electrical conductivity was measured using a powder resistance measurement device (manufactured by Mitsubishi Chemical Analytech Co., Ltd.) while applying a pressure of 4 MPa, and found to be 0.1 S/cm or less.

Subsequently, as the first heat treatment step (FIG. 4: S302), the calcium dodeca-oxide aluminum hepta-oxide (12CaO·7Al₂O₃) was subjected to heat treatment under an oxygen atmosphere, whereby the powder of calcium dodeca-oxide aluminum hepta-oxide (12CaO·7Al₂O₃) including oxygen ion radicals in the amount of 10¹⁸/cm³ or more was synthesized in the following procedure.

The powder of calcium dodeca-oxide aluminum hepta-oxide (12CaO·7Al₂O₃) was subjected to heat treatment in the oxygen atmosphere at 550° C. for 12 hours; thereafter the powder was coarsely ground again using the mortar and pestle, and then finely ground using the ball mill.

The powder after the heat treatment was confirmed to have a similar crystal structure to that before the heat treatment by the XRD measurement. It was confirmed by the ESR measurement that the calcium dodeca-oxide aluminum hepta-oxide (12CaO·7Al₂O₃) contained oxygen ion radicals in the amount of 5×10¹⁸/cm³. The specific surface area of the powder was found to be 12 m²/g when measured by the BET method. The electrical conductivity was found to be 0.1 S/cm or less.

Subsequently, as the second heat treatment step (FIG. 4: S303), the calcium dodeca-oxide aluminum hepta-oxide (12CaO·7Al₂O₃) was subjected to heat treatment under a titanium metal vapor atmosphere, whereby the powder of calcium dodeca-oxide aluminum hepta-oxide (12CaO·7Al₂O₃) having an electrical conductivity of 3 S/cm or more was synthesized in the following procedure.

First, the powder of calcium dodeca-oxide aluminum hepta-oxide (12CaO·7Al₂O₃) containing oxygen ion radicals in the amount of 10¹⁸/cm³ and titanium metal pieces ((12CaO·7Al₂O₃) powder: titanium metal pieces=1:10 (g/g)) were put into a quartz tube and sealed in a vacuum, and then were subjected to heat treatment at 700° C. for 48 hours. The heat-treated calcium dodeca-oxide aluminum hepta-oxide (12CaO·7Al₂O₃) was coarsely ground again using the mortar and pestle, and then finely ground using the ball mill.

The powder after the heat treatment was confirmed to have a similar crystal structure to that of the powder before the heat treatment by the XRD measurement. The specific surface area of the powder was found to be 13 m²/g when measured by the BET method. The electrical conductivity was found to be 3.7 S/cm.

As the carrying step (FIG. 4: S304), molding was performed by applying a pressure of 3 t/cm² to the obtained powder by using a cold isostatic press, and the obtained mold body was sintered at 800° C. for 30 hours under the oxygen atmosphere. The obtained oxide sintered body was used as a sputtering target and sputtering was performed on the co-continuous body fabricated in Example 3.

The obtained catalyst carrying co-continuous body was evaluated by being subjected to the XRD measurement, SEM observation, porosity measurement, tensile test, and BET specific surface area measurement. It was confirmed that the co-continuous body was constituted of only carbon and calcium dodeca-oxide aluminum hepta-oxide (12CaO·7Al₂O₃) by the XRD measurement. By the SEM observation, nanoparticles of the calcium dodeca-oxide aluminum hepta-oxide carried by sputtering on the co-continuous body where the nanofibers with a diameter of 20 nm extended continuously.

From the fact that the nanoparticles were carried on the co-continuous body, a reduction in specific surface area and a reduction in porosity were confirmed. The BET specific surface area measurement of the co-continuous body was measured by the mercury penetration method, and it was found to be 680 m²/g. Further, the porosity of the co-continuous body was measured by the mercury penetration method, and it was found to be 80% or greater. Furthermore, from the tensile test result, it was confirmed that the co-continuous body did not exceed the elasticity region even when a strain of 80% was added by the tensile stress and was restored to the shape before the stress application, thereby exhibiting excellent stretchability even after the carbonization.

The discharge capacity and the average discharge voltage of the zinc air battery in Example 4 are indicated in Table 4 given below. In Example 4, the discharge capacity was 1290 mAh/g and the average discharge voltage was 1.1 V.

TABLE 4

| | Average | Discharge |
|---|---|---|
| | Discharge | Capacity |
| Examples | Voltage (V) | (mAh/g) |
| Example 3 (C) | 1.0 | 1280 |
| Example 4 (C/12CaO•7Al₂O₃) | 1.1 | 1290 |
| Example 5 (C/12CaO•7Al₂O₃/Fe) | 1.3 | 1300 |
| Example 5 (C/12CaO•7Al₂O₃/Mn) | 1.3 | 1320 |
| Example 5 (C/12CaO•7Al₂O₃/Zn) | 1.2 | 1290 |
| Example 5 (C/12CaO•7Al₂O₃/Cu) | 1.2 | 1280 |
| Example 5 (C/12CaO•7Al₂O₃/Mo) | 1.2 | 1290 |
| Comparative example (C) | 0.8 | 680 |

According to the present example, a co-continuous body having a high porosity, stretchability by BET specific surface area measurement, and carrying the catalyst thereon was obtained. According to the zinc air battery using this co-continuous body for the air electrode, by using the co-continuous body having a high porosity and stretchability for the air electrode, as in Example 3, a discharge product [Zn(OH)₂] was efficiently precipitated at the discharge time, and the air electrode reaction was promoted and the overvoltage was reduced by the carrying of the catalyst, whereby an improvement in characteristics, specifically an improvement in average discharge voltage, was obtained.

### Example 5

Example 5 describes a case in which calcium dodeca-oxide aluminum hepta-oxide (12CaO·7Al₂O₃) including a metal monoatom is further carried as a catalyst on a co-continuous body formed with nanofibers produced by bacteria. A synthesis procedure of calcium dodeca-oxide aluminum hepta-oxide (12CaO·7Al₂O₃) powder is the same as that of Example 4.

As in Example 4, calcium dodeca-oxide aluminum hepta-oxide (12CaO·7Al₂O₃) with increased electrical conductivity is carried on a co-continuous body.

Next, as the metal fixing step, freezing step, and drying step (FIG. 5: S305 to S307), the co-continuous body carrying the calcium dodeca-oxide aluminum hepta-oxide (12CaO·7Al₂O₃) thereon was caused to react within a solution containing a metal salt, whereby the calcium dodeca-oxide aluminum hepta-oxide (12CaO·7Al₂O₃) including the metal monoatom was synthesized in the following procedure.

First, the co-continuous body carrying the calcium dodeca-oxide aluminum hepta-oxide (12CaO·7Al₂O₃) thereon was subjected to heat treatment in vacuo at 500° C. to remove water on the surface thereof, then was immersed in a solution of iron chloride (FeCl₃, produced by KANTO CHEMICAL CO., INC.) in the amount of 0.1 mol/L while using methanol as a solvent, and was left still under an argon atmosphere for 24 hours. Thereafter, similar to Example 1, the co-continuous body was frozen and dried, and subjected to heat treatment under a 5% hydrogen atmosphere (5% H₂/N₂) at 200° C.

The obtained catalyst carrying co-continuous body was evaluated by being subjected to the XRD measurement, SEM observation, porosity measurement, tensile test, and BET specific surface area measurement. It was confirmed that the co-continuous body was constituted of only carbon, calcium dodeca-oxide aluminum hepta-oxide (12CaO·7Al₂O₃), and metallic iron by the XRD measurement. By the SEM observation, it was confirmed that nanoparticles are carried on the co-continuous body where nanofibers with a diameter of 20 nm extended continuously. Further, from the fact that the nanoparticles and the metal were carried within the co-continuous body, a reduction in specific surface area and a reduction in porosity were confirmed. The BET specific surface area measurement of the co-continuous body was measured by the mercury penetration method, and it was found to be 660 m²/g. The porosity of the co-continuous body was measured by the mercury penetration method, and it was found to be 75% or greater. Furthermore, from the tensile test result, it was confirmed that the co-continuous body did not exceed the elasticity region even when a strain of 80% was added by the tensile stress and was restored to the shape before the stress application, thereby exhibiting excellent stretchability even after the carbonization.

The discharge capacity and the voltage of the zinc air battery in Example 5 are indicated in Table 4 given above. In Example 5, the average discharge voltage was 1.3 V. The average discharge voltage and discharge capacity of other metal species are also indicated in Table 4. From Table 4, it is understood that the average discharge voltage is higher when Fe and Mn are used as the metal species, and the discharge capacity is greatest when Mn is used. Because of high activity of Fe and Mn as an oxygen reduction catalyst, the positive electrode reaction efficiently proceeded, and the voltage was improved. It may be thought of that an efficient precipitation of the discharge product was brought because the reaction efficiently occurred especially when Mn was used.

According to the present example, a co-continuous body having a high porosity, stretchability by BET specific surface area measurement, and carrying the catalyst thereon was obtained. According to the zinc air battery using this co-continuous body for the air electrode, a discharge product [Zn(OH)₂] was efficiently precipitated at the discharge time, and the air electrode reaction was promoted and the overvoltage was reduced by the catalyst including the metal, whereby an improvement in characteristics, specifically an improvement in average discharge voltage, was obtained.

### Comparative Example

Next, a comparative example will be described. In the comparative example, a zinc air battery cell using carbon (KETJENBLACK EC600JD), which is known as an electrode for an air electrode, and manganese oxide was fabricated and evaluated. In the comparative example, a coin cell type zinc air battery similar to that in Example 1 was fabricated. Potassium chloride (1 mol/L) similar to that in Example 1 was used for the electrolyte.

Manganese oxide powder (manufactured by KANTO CHEMICAL CO., INC.), KETJENBLACK powder (manufactured by Lion Specialty Chemicals Co., Ltd.), and polytetrafluoroethylene (PTFE) powder (manufactured by Daikin Industries, Ltd.) were sufficiently ground and mixed using a mortar machine in a weight percentage of 50:30:20, and subjected to roll forming to fabricate a sheet-like electrode (thickness: 0.5 mm). The sheet-like electrode was cut in a circular shape with a diameter of 14 mm to obtain the air electrode. Conditions of the discharge test of the battery were the same as those in Example 1.

The discharge capacity of the zinc air battery of the comparative example is indicated in Table 4 along with the results of Examples 3 to 5. As indicated in Table 4, the discharge capacity of the comparative example was 680 mAh/g, which was a smaller value than that of Example 1. When the air electrode of the comparative example was observed after the measurement, part of the air electrode collapsed and dispersed in the electrolytic solution, and the electrode structure of the air electrode was found to be broken down.

Based on the results discussed above, it has been confirmed that the metal air battery of the present embodiment is excellent in capacity and voltage compared to the metal air batteries using the air electrodes formed with the known materials.

As described above, the metal air battery of the present embodiment includes an air electrode containing a conductive material and a catalyst, a negative electrode containing a metal, and an electrolyte having ionic conductivity. The conductive material contains a co-continuous body of a three-dimensional network structure in which nanostructure bodies are branched, and the catalyst contains oxide having a cage-shaped crystal structure.

The manufacturing method for an air electrode of the present embodiment includes a step of performing heat treatment on oxide having a cage-shaped crystal structure under an oxygen atmosphere to increase a concentration of oxygen ion radicals included in the oxide, a step of performing heat treatment on the oxide with the increased concentration of the oxygen ion radicals under at least one type of atmosphere selected from the group consisting of atmospheres of an alkali metal, an alkaline earth metal, and titanium vapor to increase electrical conductivity of the oxide, and a step of carrying the oxide with the increased electrical conductivity on a conductive material, wherein the conductive material contains a co-continuous body of a three-dimensional network structure in which nanostructure bodies are branched.

As described above, in the present embodiment, for the conductive material of the air electrode, a co-continuous body of a three-dimensional network structure in which a plurality of nanostructure bodies are integrated by non-covalent bonds is used, and oxide having a cage-shaped crystal structure is used for the catalyst of the air electrode. As a result, in the present embodiment, a metal air battery may be fabricated with a material having a low environmental burden without using a fluorine resin, a rare metal, or the like as a binder, thereby making it possible to provide a metal air battery that is not required to be collected. Furthermore, by using oxide having a cage-shaped crystal structure as a catalyst, it is possible to obtain an excellent effect in which the overvoltage of the air electrode is reduced and the discharge voltage is significantly improved.

The metal air battery using the air electrode of the present embodiment is easy to handle. The metal air battery of the present embodiment does not include elements used for soil fertilizer, does not include metal elements other than the metals contained in rain water, sea water or the like, and is naturally decomposed, so that an environmental burden of the metal air battery of the present embodiment is significantly low.

Such battery may be effectively used as a variety of drive sources of a disposable battery in everyday environment, a sensor used in soil, and the like. According to the present embodiment, it is possible to increase the discharge capacity of the metal air battery by selecting an appropriate material for the negative electrode metal species and the electrolytic solution species.

Note that the present disclosure is not limited to the embodiments described above, and it is apparent to those skilled in the art to carry out various modifications and combinations within the technical ideas of the present disclosure.

### REFERENCE SIGNS LIST

101 Air electrode
102 Negative electrode
103 Electrolyte

1. A metal air battery, comprising:
an air electrode containing a conductive material and a catalyst;
a negative electrode containing a metal; and
an electrolyte having ionic conductivity,
wherein the conductive material contains a co-continuous body of a three-dimensional network structure where nanostructure bodies are branched, and
the catalyst contains oxide having a cage-shaped crystal structure.

2. The metal air battery according to claim 1, wherein calcium dodeca-oxide aluminum hepta-oxide (12CaO·7Al₂O₃) is used as the oxide.

3. The metal air battery according to claim 1, wherein the oxide includes a monoatomic metal.

4. The metal air battery according to claim 3, wherein the monoatomic metal contains at least one type of element selected from the group consisting of iron, manganese, zinc, copper, and molybdenum.

5. A manufacturing method for an air electrode, the method comprising:
performing heat treatment on oxide having a cage-shaped crystal structure under an oxygen atmosphere to increase a concentration of oxygen ion radicals included in the oxide;
performing heat treatment on the oxide with the increased concentration of the oxygen ion radicals under at least one type of atmosphere selected from the group consisting of atmospheres of an alkali metal, an alkaline earth metal, and titanium vapor to increase electrical conductivity of the oxide; and
carrying the oxide with the increased electrical conductivity on a conductive material,
wherein the conductive material contains a co-continuous body of a three-dimensional network structure where nanostructure bodies are branched.

6. The manufacturing method for the air electrode according to claim 5, further comprising:
fixing a monoatomic metal to the oxide.

7. The metal air battery according to claim 2, wherein the oxide includes a monoatomic metal.
